(19) United States
(12) Patent Application Publication
(10) Pub. No.: US 2006/0185271 A1
(43) Pub. Date: Aug. 24, 2006

(54) Severe weather protection system

(76) Inventors: Kurt Christensen, Punta Gorda, FL (US); Kathy Harroff, Mason, OH (US)

Correspondence Address: STINSON MORRISON HECKER LLP;ATTN: PATENT GROUP, 1201 WALNUT STREET, SUITE 2800, KANSAS CITY, MO, 64106-2150, US

(21) Appl. No.: 11/347,349

(22) Filed: Feb. 3, 2006

Related U.S. Application Data
(60) Provisional application No. 60/654,864, filed on Feb. 22, 2005.

(51) Int. Cl. E06B 3/26

(52) U.S. Cl. 52/202

(57) ABSTRACT

A system for protecting windows and doors during severe weather. The system comprises pre-drilled apertures in the structure surrounding the window or door to be protected and housing threaded inserts. Pre-cut plywood protective panels, sized to fit over the window or door to be protected, and having pre-drilled apertures corresponding to the structure apertures are placed over the window or door and the apertures are aligned. The protective panels are secured to the structure by flanged bolts. “L” brackets may be used in place of some of the threaded inserts and flanged bolts. During periods of non-use, the threaded inserts, bolts and “L” brackets remain attached to the structure to prevent loss. The protective panels are numbers to correspond to specific windows or doors and are stored until needed.

### CROSS-REFERENCE TO RELATED APPLICATIONS

This application claims priority to U.S. Provisional Application 60/654,864, filed Feb. 22, 2005, which is hereby incorporated by reference herein in its entirety.

### STATEMENT REGARDING FEDERALLY SPONSORED RESEARCH OR DEVELOPMENT

Not applicable.

### BACKGROUND OF THE INVENTION

This invention relates generally to storm protection and, more particularly, to a removable and reusable system for use in securing and protecting windows and doors during severe weather.

Seasonal storm conditions are unpredictable and often dangerous. Despite the regular occurence of such storms, there are often shortages of materials for use in securing and protecting the windows and doors of a home or other structure. Once the public is aware of an approaching storm, the shortage in protective materials and delays in obtaining and utilizing such materials, including finding the necessary material, cutting the material to fit specific windows and doors, and securing the protective material to the structure, presents a potential hazard by prolonging storm preparations and delaying evacuations. Conventionally, plywood or other similar material is fastened to the exterior wall surrounding windows and doors with nails or screws to prevent damage. After the severe weather and danger has passed, the protective materials are typically discarded and unsightly holes made by the nails and screws remain in the building exterior. What is needed is a convenient and simple method of securing and protecting the windows and doors of a structure against storm damage. The present invention seeks to provide a severe weather protection system utilizing removable and reusable components including brackets and bolts for quickly and efficiently securing pre-cut plywood panels in place over window and door openings.

### BRIEF SUMMARY OF THE INVENTION

The present invention provides an improved storm protection system by providing a pre-installed mounting system for attaching plywood panels over window and door openings. The mounting system includes a plurality of pre-inserted threaded inserts for securing bolts into the exterior of the structure, such inserts being positioned adjacent to, above and below a window or door assembly.

A severe weather protection system for shielding the windows and doors of a structure comprises at least two receiving members for insertion into at least two corresponding apertures located in the structure, said at least two corresponding apertures located in spatial relation to each other around the perimeter of the structure opening. The receiving members have a threaded interior surface and are designed to receive corresponding securing members for securing a protective cover over the opening, the protective cover being larger in size than the structure opening. At least two apertures generally aligned with the receiving members are located in the protective cover, such that the protective cover is capable of being secured to the structure exterior by inserting securing members through the protective cover apertures and securing them within the receiving members.

Preferably, the system comprises four threaded receiving members, one receiving member being located adjacent and to the outside of each corner of a substantially rectangular opening, such as a window or door. In an alternative embodiment, “L” shaped brackets may be used in place of the threaded receiving members and securing members located below the lower edge of the window.

### BRIEF DESCRIPTION OF THE DRAWINGS

FIG. 1 is an elevational view of the protective system according to the present invention, showing the protective cover in place;

FIG. 2 is an elevational view of the protective system according to the present invention, showing the protective cover in dotted lines;

FIG. 3 is a side view of the present invention illustrating the protective system prior to mounting of the protective cover;

FIG. 4 is a top view of the present invention illustrating the protective system and threaded inserts prior to mounting of the protective cover;

FIG. 5 is a side view of the present invention illustrating the protective system, threaded inserts, securing bolts and “L” brackets after mounting of the protective cover;

FIG. 6 is a detailed view of the threaded inserts and securing bolts of the present invention prior to mounting of the protective cover;

FIG. 7 is a detailed view of the threaded inserts and securing bolts of the present invention after mounting of the protective cover.

FIG. 8 is an elevational view of the protective cover of the present invention, depicting four securing apertures.

### DETAILED DESCRIPTION OF PREFERRED EMBODIMENT

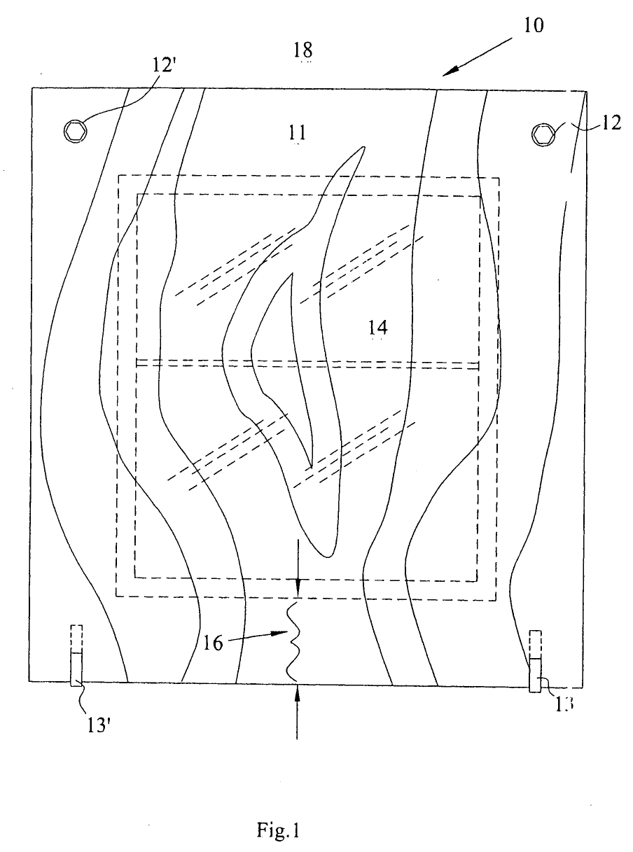

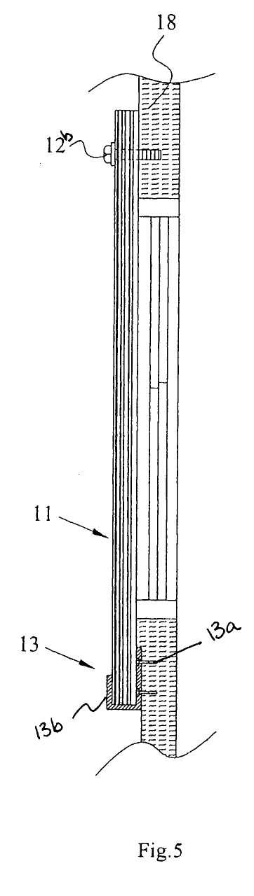

Referring initially to FIGS. 1, 2 and 3, the invention is designated overall by the numeral 10. Structure wall 18 provides attachment locations 12, 12′, 13 and 13′. Protective cover 11 overlays window 14, protecting the glass contained in window 14. Wall bearing surface 16, being substantially larger than window 14, provides a planar support for protective cover 11 which directs impact forces to wall 18 and away from window 14. Looking to FIG. 5, protective cover 11 is secured in place over window 14 by threaded inserts 12a, securing bolts 12b and “L” brackets 13b.

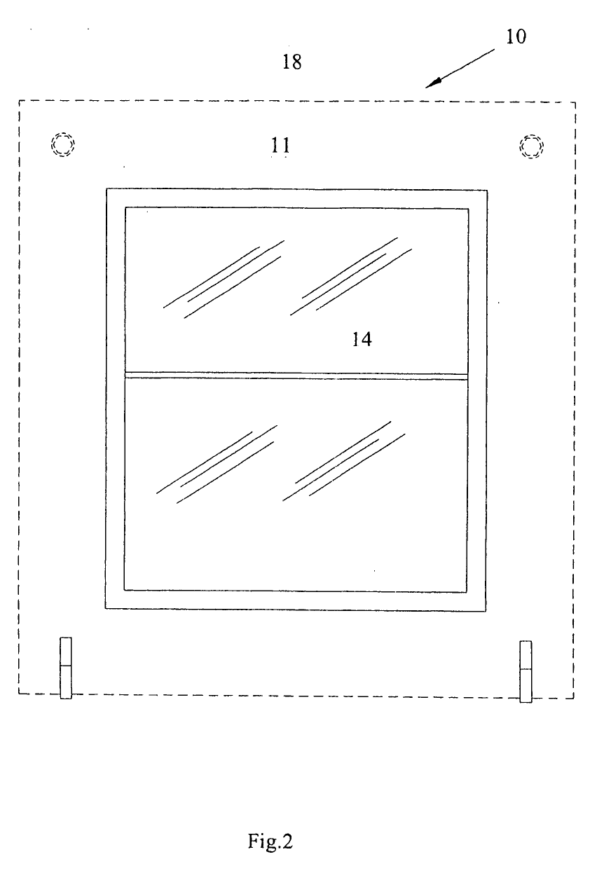

As shown in FIGS. 1 and 2, protective cover 11 is generally rectangular in shape. The rectangular shape is preferred as it is generally more readily available, is less expensive to obtain and is easier to locate at commercial retail stores. Additionally, as the majority of windows and doors are generally rectangular in shape, the rectangular shape of protective cover 11 more readily compliments the area to be covered. It is also easier and quicker to use conventional tools to cut the protective cover 11 to the necessary size by utilizing a rectangular shape.

Protective cover 11 is larger in size than the window 14 or other structure wall opening to be covered. The edges of protective cover 11 extend past the window 14 perimeter and provide a location for securing members to pass through the protective cover 11 and into the structure wall 18. While specific dimensions of protective cover 11 will depend on the size of the window 14 or opening to be covered, as shown in FIGS. 1 and 2, protective cover 11 must be large enough to adequately cover window 14 and provide a sufficient perimeter of excess material to accommodate securing members while at the same time providing sufficient material extending in each direction around each securing member. Securing members are located approximately equi-distant from the edges of protective cover 11. This will enable a stable and secure connection of securing members through protective cover 11 and into structure wall 18.

Protective cover 11 is preferably approximately 12 to 36 inches larger in height and width than window 14. Protective cover 11 is more preferably approximately 18 to 32 inches larger in height and width than window 14 and is most preferably approximately 24 inches larger in height and width than window 14. By way of example only, to cover a window measuring 3 feet in width by 4 feet in height, protective cover 11 would preferably have dimensions of 4 to 6 feet in width by 5 to 7 feet in height, would more preferably have dimensions of 4.5 to 5.5 feet in width by 5.5 to 6.5 feet in height and would most preferably have dimensions of 5 feet in width by 6 feet in height. Similarly, rectangular protective cover 11 can cover a window of not only any size, but also any shape. By way of example, for an oval window measuring 3 feet at its widest point by 4 feet at its tallest point, protective cover would preferably have the same dimensions as above.

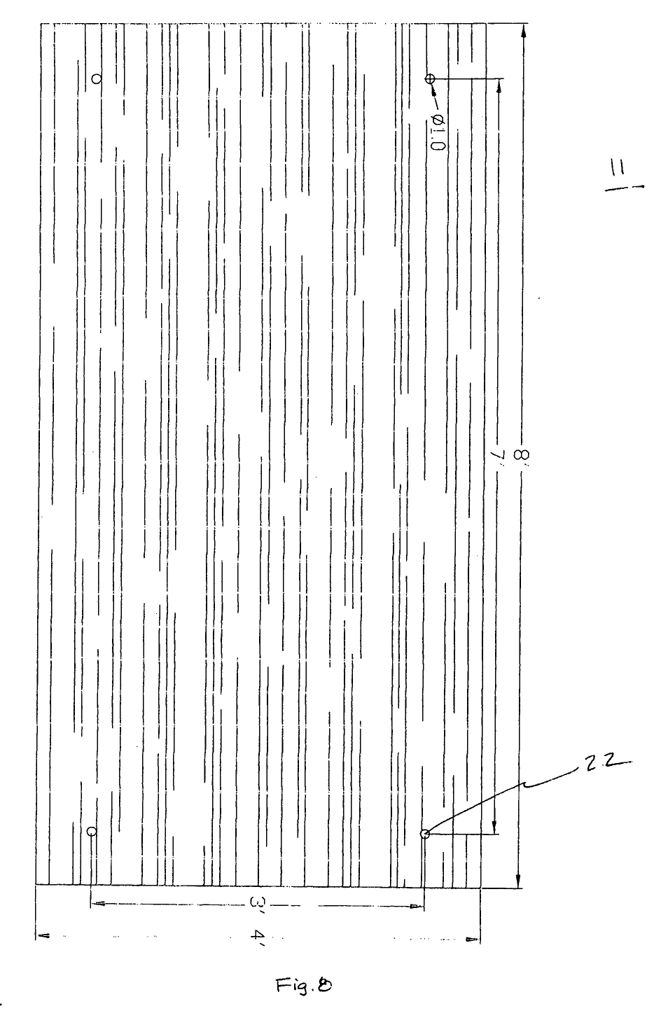

Protective cover 11 is made of plywood, which is generally readily available and inexpensive, yet is light-weight and durable. Thickness of protective cover 11 can vary from approximately ⅛ inch to 1 inch or more, depending on the availability of material. As shown in FIG. 8, protective cover 11 contains four securing apertures 22 for securing protective cover 11 over window 14 and onto structure wall 18. Securing apertures 22 are located in the four corners of protective cover 11, preferably spaced equi-distant from each edge of protective cover 11.

In alternative embodiments (not depicted) protective cover 11 may be other shapes than generally rectangular, such as hexagonal or oval. In such an instance, securing apertures 22 are located around the edge of protective cover 11 allowing sufficient excess material between securing aperture 22 and edge of protective cover 11 for stability purposes, securing aperture 22 preferably being spaced approximately equi-distant apart from each other in order to sufficiently secure protective cover 11 to structure wall 18. Protective cover 11 may also be made of material other than plywood, provided the material is light-weight and durable. For example, protective cover 11 may be made of fiberglass, polyurethane, aluminum, or virtually any other synthetic, metallic or wooden material commonly used in the construction industry and suitable for exterior use.

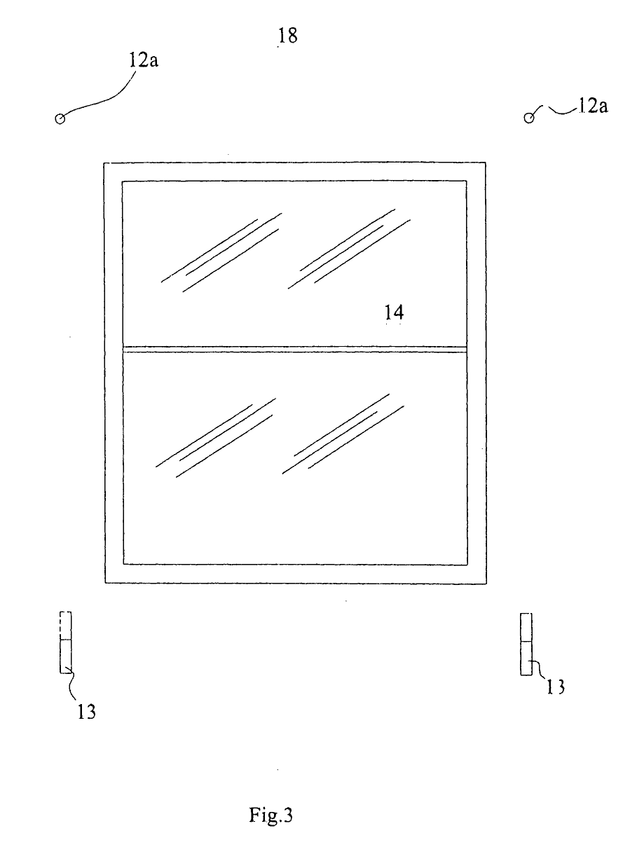

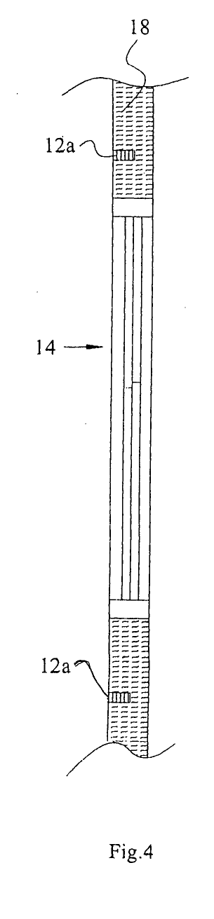

As shown in FIGS. 1, 2 and 3, structure wall 18 houses window 14. Protective cover 11 is secured over window 14 by means of securing members at attachment locations 12, 12′, 13, and 13′. Securing members consist of securing bolts 12b and “L” brackets 13b. As shown in FIGS. 3 and 4, threaded inserts 12a are located in structure wall 18 above and to the outside of the upper edge of the window 14. As shown in FIGS. 3 and 5, two “L” brackets 13b are located below and to the outside of the lower edge of window 14. The lower edge of protective cover 11 rests inside the “L” brackets 13b. Securing apertures 22 of protective cover 11 are aligned with threaded inserts 12a. Securing bolts 12b are inserted through protective cover apertures 22 and secured into threaded inserts 12a to keep protective cover 11 firmly secured against structure wall 18.

Threaded inserts 12a are secured within the exterior of structure wall 18 above and to the outside of the upper edge of window 14. If threaded inserts 12a are utilized throughout protective system 10 in lieu of “L” brackets 13b, additional threaded inserts 12a are secured within the exterior of structure wall 18 below and to the outside of the lower edge of window 14. Cavities are made within the exterior of structure wall 18 by drilling or other means commonly used in the construction industry. Threaded inserts 12a are then inserted into the cavities and secured therein by means of friction, adhesive or other bonding or joining methods commonly used in the construction industry. Threaded inserts 12a are made of non-corrosive metal. Other durable and non-corrosive material commonly used in the construction industry and appropriate for exterior use may also be utilized for threaded inserts. The depth and diameter of threaded inserts 12a is sufficient to accommodate securing bolts 12b.

Securing bolts 12b are preferably flanged bolts and are made of non-corrosive metal or other durable material commonly used in the construction industry and appropriate for exterior use. Securing bolts 12b may be of any diameter commonly used in the construction industry, but are preferably between approximately ¼ inch and ¾ inches. The length of securing bolts 12b must be sufficient to pass entirely through the thickness of protective cover 11 and provide adequate length for securing into threaded inserts 12a. Preferably, length of securing bolts 12b is between approximately 2 inches and 3 inches. Lengths shorter or longer, however, may be utilized depending on the thickness of protective cover 11 and structure wall 18.

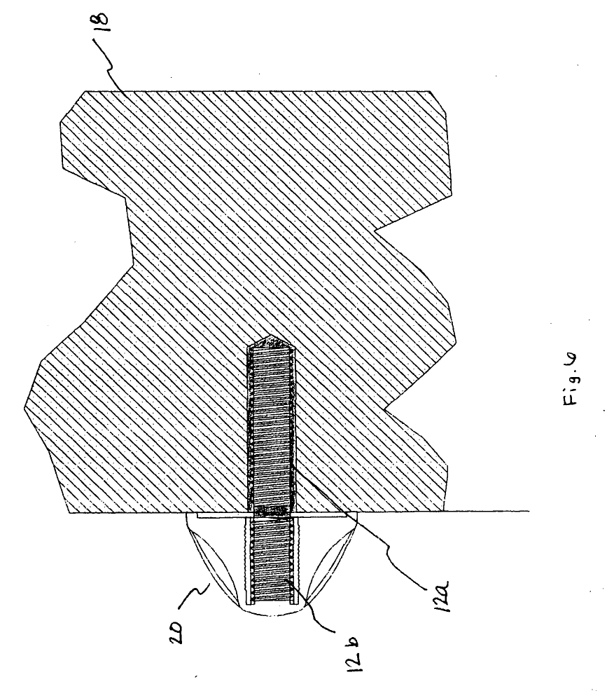

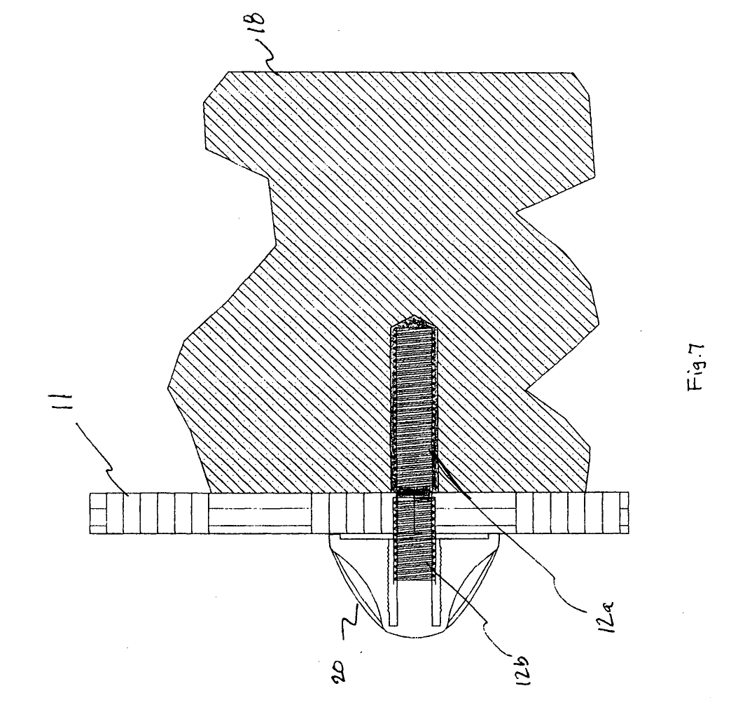

As shown in FIGS. 6 and 7, knobs 20 are secured to the exterior end of securing bolts 12b. Knobs 20 assist in installing securing bolts 12b into threaded inserts 12a. Knobs 20 are preferably dome-shaped for ease of use and are made of plastic. Knobs 20, however, may be other shapes such as “T”-shaped, spherical or other shapes commonly used and available within the construction industry. Similarly, knobs 20 may be made of other materials such as metal, wood or other materials suitable for use outdoors. Knobs 20 may be painted or otherwise decorated for aesthetic purposes. Although knobs are preferred, protection system 10 may be utilized without knobs 20.

“L” brackets 13b are secured to the exterior of structure wall 18 in a location below and outside of the lower edge of window 14. As shown in FIGS. 3 and 5, “L” brackets 13b are secured to structure wall 18 by means of screws 13a. As shown in FIG. 5, “L” brackets are generally “L” shaped with a lip extending upward on the side that is not adjacent to structure wall 18. This lip assists in securing protective cover 11. “L” brackets 13b are preferably made of non-corrosive metal. “L” brackets 13b may also be secured to structure wall 18 by means of nails or other securing means commonly used in the construction industry and appropriate for exterior use. In addition, “L” brackets 13b may be made of other materials commonly used in the construction industry appropriate for exterior use.

Although the previously described protective system 10 comprises two threaded inserts 12a located above the upper edge of window 14, two flanged bolts 12b located on the upper end of protective cover 11 and two “L” brackets 13b located below the lower edge of window 14, other arrangements are within the scope of the present invention. For example, another preferred embodiment (not depicted) comprises four flanged bolts 12b, one flanged bolt located in each corner of protective cover 11, and no “L” brackets. Yet another embodiment comprises six threaded inserts 12a, wherein three threaded inserts are located above the upper edge of window 14 and three threaded inserts are located below the lower edge of window 14, and utilizing six corresponding flanged bolts 12b and securing apertures 22. A further embodiment comprises eight threaded inserts 12a, wherein three threaded inserts are located above the upper edge of window 14, three threaded inserts are located below the lower edge of window 14, and one threaded insert is located to the outside of each side of window 14, preferably centered within the height of window 14. In this additional embodiment, protective cover 11 comprises eight corresponding securing apertures 22 and flanged bolts 12b. In the same manner, an almost endless combination of flanged bolts 12b and “L” brackets 13b may be utilized to secure protective cover 11 over window 14.

In addition to flanged bolts, additional removable securing members may include other types of bolts commonly utilized within the construction industry and suitable for exterior use. Additionally, securing members other than bolts which are commonly used in the construction industry, such as screws and the like, may be used, provided they are removable. In addition to “L” brackets, other shelf-type brackets may also be utilized to support and secure protective cover 11.

As depicted in FIGS. 6 and 7, decorative knob 20 may be secured to the exterior end of flanged bolt 12b for ease of installation and may be decorated or otherwise painted to match or coordinate with the structure wall 18 for aesthetic purposes. Additionally, a decorative design (not depicted) may be used on the face of the external section to the “L” brackets 13b to provide a more attractive aesthetic.

While protective cover 11 preferably overlays structure window 14, it may, of course, overlay a door, a glass insert within a door, or any other opening within a structure wall which is in need of protection during severe weather. The structure wall opening in need of protection would generally contain glass or other breakable material necessitating protection from severe weather. Protective cover 11 would merely need to be adjusted in size to accommodate the shape and size of the structure wall opening. In-addition, threaded inserts 12a and “L” brackets 13b, if utilized, would be secured to the structure wall either above, below or adjacent to the structure wall opening being covered. As discussed above, the general shape of protective cover 11 would preferably remain rectangular for ease of purchase, although other shapes could be utilized.

In operation, pre-cut plywood panels 11 are placed up to the window or door opening 14. The securing apertures 22 are aligned over the pre-inserted threaded inserts 12a. Securing bolts 12b are inserted through the plywood panels and tightened within threaded inserts 12a to secure protective plywood panel 11 over the window or door opening 14. The plywood panels 11 are preferably numbered so that once the panel 11 is cut to fit the dimensions of a specific window or door, it can easily be removed, stored and later replaced on the appropriate window or door in a quick and efficient manner.

During the first use or prior to the first use of the protective system of the present invention, a protective cover 11 is cut for each window 14 or structure wall opening in need of protection. Each protective cover 11 is numbered to correspond to a specific window 14 or structure opening. Similarly, during or prior to the first use of the system, holes are drilled or otherwise made in the structure wall at the appropriate location and threaded inserts 12a are inserted and secured therein. Apertures are also drilled or otherwise made in each protective cover 11 during or prior to the first use of the protective system of the present invention. These apertures are located so as to correspond to the holes made in the structure wall. Alternatively, the apertures may first be made in the protective cover 11 and then in the structure wall. If used, “L” brackets 13b are secured to the structure wall in the appropriate location. As noted above, the protective system may utilize only threaded inserts 12a and securing bolts 12b or may utilize a combination of threaded inserts 12a, securing bolts 12b and “L” brackets 13b. These securing members remain attached to the structure during periods of non-use for storage and to promote quick and easy installation when needed. When not in use, protective covers 11 are removed and stored.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and sub-combinations are of utility and may be employed without reference to other features and sub-combinations. This is contemplated by and is within the scope of the claims.

What is claimed and desired to be secured by Letters Patent is as follows:

1. A severe weather protection system for shielding the windows and doors of a structure, said system comprising:
at least two receiving members for insertion into at least two corresponding cavities located in a structure, said at least two corresponding cavities located in spatial relation to each other around the perimeter of an opening in said structure; and
each of said at least two receiving members being designed to receive a corresponding securing member for securing a protective cover over the exterior of said structure opening, said protective cover being larger in dimension than said structure opening.

2. The system of claim 1, wherein said protective cover further comprises at least two apertures generally aligned with said at least two receiving members, such that said protective cover is capable of being secured to the exterior of said structure by inserting each of said securing members through one of said protective cover apertures, and securing each of said securing members within one of said at least two receiving members.

3. The system of claim 1, wherein said at least two receiving members further comprise internal threads.

4. The system of claim 1, wherein said securing members are bolts.

5. The system of claim 1, further comprising four receiving members, wherein each of said four receiving members is located adjacent to a different corner of said structure opening and wherein said structure opening is substantially rectangular.

6. The system of claim 1, further comprising removable knobs covering the exterior ends of said securing members.

7. A severe weather protection system for shielding the windows and doors of a structure, said system comprising:
at least two cavities located within the exterior of a structure wall, said at least two cavities located around the perimeter of an opening in said structure wall;
at least two securing members fitting into said at least two structure cavities; and
a protective cover having apertures corresponding to said structure cavities, wherein said protective cover is secured over the exterior of said structure wall opening and to said structure by said at least two securing members.

8. The system of claim 7, wherein said at least two cavities comprise internal threads.

9. The system of claim 7, wherein said at least two securing members are bolts.

10. The system of claim 7, further comprising four cavities, wherein each of said four cavities is located adjacent to a different corner of said structure wall opening, wherein said structure wall opening is substantially rectangular.

11. The system of claim 7, further comprising removable knobs covering the exterior ends of said at least two securing members.

12. A severe weather protection system for shielding the windows and doors of a structure, said system comprising:
at least two receiving members for insertion into at least two corresponding cavities located in a structure, said at least two corresponding cavities located above the upper edge perimeter of an opening in said structure;
each of said at least two receiving members being designed to receive a corresponding securing member for securing a protective cover over the exterior of said structure opening, said protective cover being larger in dimension than said structure opening; and
at least one shelf bracket secured to said structure and located below the lower edge perimeter of said structure opening, said at least one shelf bracket designed to support the lower edge of said protective cover.

13. The system of claim 12, wherein said protective cover further comprises at least two apertures generally aligned with said at least two receiving members, such that each of said securing members is capable of insertion through one of said protective cover apertures, and each of said securing members is capable of being secured within one of said at least two receiving members.

14. The system of claim 12, wherein said at least two receiving members further comprise internal threads.

15. The system of claim 12, wherein said securing members are bolts.

16. A severe weather protection system for shielding the windows and doors of a structure, said system comprising:
four receiving members for insertion into four corresponding cavities located in a structure, said four receiving members comprising internal threads and said four corresponding cavities located in spatial relation to each other around the perimeter of an opening in said structure, wherein two of said four cavities are located above the upper edge perimeter of said structure opening and two of said four cavities are located below the lower edge perimeter of said structure opening;
a protective cover larger in dimension that said structure opening, said protective cover further comprising four apertures generally aligned with said four receiving members; and
four flange bolts for securing said protective cover over the exterior of said structure opening, each of said four flange bolts being capable of insertion through one of each of said four apertures and being capable of reception into one of each of said four receiving members.

17. A severe weather protection system for shielding the windows and doors of a structure, said system comprising:
two receiving members for insertion into two corresponding cavities located in a structure, said two receiving members comprising internal threads and said two corresponding cavities located in spatial relation to each other above the upper edge perimeter of a structure opening;
a protective cover larger in dimension that said structure opening, said protective cover further comprising two apertures generally aligned with said two receiving members;
two flange bolts for securing said protective cover over the exterior of said structure opening, each of said two flange bolts capable of insertion through one of each of said two apertures and capable of receipt into one of each of said two receiving members; and
two shelf brackets secured to said structure, located in spatial relation to each other below the lower edge perimeter of said structure opening, said two shelf brackets designed to support the lower edge of said protective cover.

18. A method of protecting windows and doors during severe weather, said method comprising the steps of:
pre-drilling at least two cavities in a structure, said pre-drilled cavities located in spatial relationship around an opening in an exterior structure wall;
pre-drilling at least two apertures in a protective cover, said at least two apertures corresponding to said pre-drilled structure cavities such that said at least two apertures are capable of alignment over said at least two structure cavities;
aligning said pre-drilled protective cover apertures over said pre-drilled structure apertures; and
securing said protective cover to said structure with securing members.

19. The method as set forth in claim 18, wherein said securing members comprise at least two bolts and wherein said at least two pre-drilled structure cavities comprise internal threads for receiving said at least two bolts.

20. The method as set forth in claim 18, wherein said pre-drilled cavities are spaced apart from each other around the perimeter of said exterior structure wall opening.

21. A method of protecting windows and doors during severe weather, said method comprising the steps of:
aligning pre-drilled apertures of a pre-numbered protective cover over corresponding numbers of cavities pre-drilled into a structure; and
securing said protective cover to said structure with securing members.
